(19) United States
(12) Patent Application Publication
(10) Pub. No.: US 2014/0067964 A1
(43) Pub. Date: Mar. 6, 2014

(54) TARGETED STATUS UPDATES

(71) Applicants: Michael Grishaver, Portola Valley, CA (US); Qi Liu, Saratoga, CA (US)

(72) Inventors: Michael Grishaver, Portola Valley, CA (US); Qi Liu, Saratoga, CA (US)

(73) Assignee: Linkedln Corporation, Mountain View, CA (US)

(21) Appl. No.: 13/601,971

(22) Filed: Aug. 31, 2012

(51) Int. Cl. G06F 15/16

(52) U.S. Cl. 709/206

(57) ABSTRACT

Techniques for designating a desired target audience to receive a message or status update are described. Consistent with some embodiments, an authorized representative of an entity or organisation represented in a social graph of a social network service is presented with a variety of member profile attributes from which to select targeting criteria for defining a desired target audience to receive a message or status update published on behalf of the entity or organization. With some embodiments, the selectable profile attributes correspond with those possessed or associated with the members of the social network service who have subscribed to receive messages or status updates published on behalf of the entity or organisation.

### TECHNICAL FIELD

The present disclosure generally relates to data processing systems. More specifically, the present disclosure relates to methods, systems and computer program products for enabling a representative of an organization (e.g., a company, a school, a government entity, a non-profit, or other organization) to target members of a social network service to be recipients of a message (e.g., a status update) published on behalf of the organization by specifying various member profile attributes.

### BACKGROUND

Online or web-based social network services provide their users with a mechanism for defining, and memorializing in a digital format, their relationships with other people. This digital representation of real-world relationships is frequently referred to as a social graph. As these social network services have matured, many of the services have expanded the concept of a social graph to enable users to establish or define relationships or associations with any number of entities and/or objects in much the same way that users define relationships with other people. For instance, with some social network services and/or with some web-based applications that leverage a social graph that is maintained by a third-party social network service, users can indicate a relationship or association with a variety of real-world entities and/or objects. For example, users may take action to expressly indicate a favorable opinion of, or an interest in, different types of content (e.g., web-based articles, blog postings, books, photographs, videos, audio recordings, music, and so forth). Typically, a user's expression of opinion or interest is captured when a user interacts with a particular graphical user interface element, such as a button, which is generally presented in connection with the particular entity or object and frequently labelled in some meaningful way (e.g., “like”, “+1”, “follow”).

In addition to hosting a vast amount of social graph data, many social network services maintain a variety of personal information about their members. For instance, with many social network services, when a user registers to become a member, the member is prompted to provide a variety of personal or biographical information, which may be displayed in a member's personal web page. Such information is commonly referred to as personal profile information, or simply “profile information,” and when shown collectively, it is commonly referred to as a member's profile. For instance, with some of the many social network services in use today, the personal information that is commonly requested and displayed as part of a member's profile includes a person's age, birthdate, gender, interests, contact information, residential address, home town and/or state, the name of the person's spouse and/or family members, and so forth. With certain social network services, such as some business or professional network services, a member's personal information may include information commonly included in a professional resume or curriculum vitas, such as information about a person's education, the company at which a person is employed, an industry in which a person is employed, a job title or function, an employment history, skills possessed by a person, professional organisations of which a person is a member, and so on.

Because social network services maintain vast amounts of social graph and member profile data, companies offering various products and services have naturally gravitated to these social network services with a view to advertising their products and services. Accordingly, many social network services provide various mechanisms by which an advertiser can embed a display advertisement in a web page when that web page is being presented to a member of the social network service who has various member profile attributes or characteristics. However, many users find the presentation of display advertisements to be annoying, and consequently, the effectiveness of these conventional advertising techniques is limited.

### DESCRIPTION Of THE DRAWINGS

Some embodiments are illustrated by way of example and not limitation in the FIGS. of the accompanying drawings, in which:

FIG. 1 is a block diagram illustrating various components or functional modules of a social network service, consistent with some embodiments;

FIG. 2 is a user interface diagram illustrating an example of user interface or web page for a company represented as an entity in a social graph maintained by a social network service, consistent with some embodiments;

FIGS. 3 and 4 are user interface diagrams illustrating examples of user interfaces or web pages enabling a company representative to publish a message or status update, and to select various member profile attributes of members of a social network service who are subscribed to (e.g., following) the company, for purposes of targeting members to receive the message or status update, consistent with some embodiments of the invention;

FIG. 5 is a user interface diagram illustrating an example of a user interface or web page having a personalized data feed or content stream via which a member of a social network service receives messages or status updates, according to some embodiments;

FIG. 6 is a user interface diagram illustrating an example of a user interface enabling a representative of a school (e.g., a college or university) to target members of a social network service to receive a message published on behalf of the school, according to some embodiments of the invention;

FIG. 7 is a flow diagram illustrating the method operations that occur during a method to facilitate the targeting of members of a social network service as recipients of a message or status update, according to some embodiments of the invention; and

FIG. 8 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products that individually enable an authorized representative of an organization to target members of a social network service to be recipients of a message by specifying various member profile attributes, when the members of the social network service have taken some express action to indicate an interest in, or otherwise subscribe to receive information from, the organization. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Consistent with some embodiments, a social network service provides organizations (e.g., companies, schools, government entities, non-profits, or other types of organizations) with an opportunity to establish a presence within a social network service, thereby providing visibility to the many members of the social network service. For instance, much like a member has a member profile page, the social network service may simply provide organizations with the ability to generate one or more customized web pages that are dedicated to presenting information about the organization. In some instances, the web pages are customizable by one or more representatives of the organization, but are generally hosted by the provider of the social network service. The web page for an organization may be semi-structured, such that a representative of the organization can simply enter or input various items of information, and the resulting web page will present the information in various content modules having a uniform look and feel that is determined by the provider of the social network service. In some instances, an organization may generate multiple web pages that are associated with one another, or have some hierarchical structure that is either predefined by the provider of the social network service, or established by the organization. For instance, in the particular case of a company, a representative of the company may establish a primary company page, and then one or more related pages dedicated to the products and/or services offered by the company. Similarly, in the case of a university, a representative of the university may establish a primary university web page, and then have several related web pages dedicated to the various departments within the university. Certainly, with other scenarios, other web page arrangements and hierarchies are possible.

With some embodiments, an organisation's presence within the social network service may he facilitated by representation of the organization as an entity in a social graph maintained by the social network service. For example, consistent with some embodiments, a social graph is implemented with a specialised graph data structure in which various entities (e.g., people, companies, schools, government institutions, non-profits, and other organizations) are represented as nodes connected by edges, where the edges have different types representing the various associations and/or relationships between the different entities. Although other techniques may be used, with some embodiments the social graph data structure is implemented with a graph database. Accordingly, if a member of the social network service with the name Jeffrey Beaner graduated from Princeton University, this particular association would be represented in the social graph data structure by a node representing the member, Jeffrey, being connected via an edge to another node representing the entity or organization, Princeton University, where the particular edge type indicates the specific type of association—in this case, Jeffrey's status as a graduate of Princeton University. Consequently, at least with some embodiments, an organization may have a presence within a social graph of a social network service without necessarily having any particular web-based content that is hosted by the social network service.

With some embodiments, only members of the social network service who are authorized representatives of a particular organization are provided the ability to establish a formal presence on behalf of an organization with the social network service. For instance, with some embodiments, the social network service may be role-based, such that each member may be assigned various roles that establish various privileges. Depending upon a member's role, the member may be able to perform various actions, such as, generate a web page on behalf of the organization, generate and/or edit content presented via a web page of the organization, and/or publish messages such as status updates or otherwise direct communications to other members of the social network service on behalf of the organization. There are many techniques beyond the scope of the present inventive subject matter that may be used to validate or verify the identity and authenticity of a member upon assigning that member a particular role and corresponding privileges. For instance, at least with some embodiments, a member must verify an email address that corresponds with a known email domain of the organization: before that member will be granted a certain role and the corresponding privileges.

Consistent with some embodiments, with proper authorization, certain representatives of an organization can publish messages (referred to herein as “status updates”) that are viewable to other members of the social network service via one or more data feeds or content streams. A data feed or content stream consistent with embodiments of the invention may be known to those skilled in the art by a variety of different names, including a “stream.” “status update stream,” “network update stream,” and/or “news feed.” Similarly, skilled artisans may refer to this type of message by many different names, including a “status update,” “tweet,” or simply, and generically, as a message. In any case, when an authorized representative of an organization publishes a status update, the status update may appear in a content stream presented on the web page of the particular organization on whose behalf the status update is being published. Additionally, the status update may appear in a personalized content stream of those members of the social network service who have taken some action to subscribe to receive messages published on behalf of the organization. For example, a member of the social network service may subscribe to receive messages or status updates published on behalf of an organization by simply selecting or otherwise interacting with a graphical user interface element (e.g., a button) presented on a web page in connection with the organization. The graphical user interface element (e.g., button) may be labelled with the text, “follow,” “like,” “+1,” or something similar. In other instances, the relationship that a member has with a particular entity or organization as defined in the social graph may automatically result in the member being subscribed to receive information from a particular entity. For example, if a member indicates in his or her member profile that the member is employed with a particular company, attending a particular school, graduated from a particular school, and so forth, this information may be used as the basis for automatically subscribing the member to receive information published on behalf of a particular entity or organization.

In many instances, organizations may have an extremely large number of members of the social network service who have subscribed to receive messages or status updates on behalf of an organization. However, there may be circumstances under which an authorized representative of an organization intends to reach a limited audience or a specific set of members with a particular message or status update. For instance, a company representative may desire to publish a status update that is relevant only to software engineers. Similarly, an administrator or representative of a university may desire to publish a status update that is relevant only to members of the social network service who are currently attending the university and who are majoring in English. Accordingly, consistent with some embodiments of the invention, the social network service includes a member targeting mechanism that enables a content publisher (e.g., a representative of an organization authorized to publish status updates on behalf of the organization) to specify various member profile attributes for the purpose of selecting the members who will receive a status update in a content stream personalized for the member.

With some embodiments, the targeting mechanism includes a graphical user interface that enables the authorized representative of an organization to select various member profile attributes or characteristics possessed by a set of members of the social network service, who are following the organization or have otherwise subscribed to receive messages or status updates from the organization. As the authorized representative interacts with the user interface and selects various member profile attributes or characteristics, the user interface is dynamically updated to indicate the size of the target audience—that is, the number of members who possess the selected profile attributes and will therefore receive the published message or status update. Consequently, various authorized representatives of an organization can tailor their messages or status updates to a particular intended audience, and then target or select the audience (e.g., the members who will receive the message or status update in their personalized content streams) by specifying the various member profile attributes or characteristics that a message recipient should possess. Other advantages of the present inventive subject matter will be readily apparent from the description of the various figures that follows.

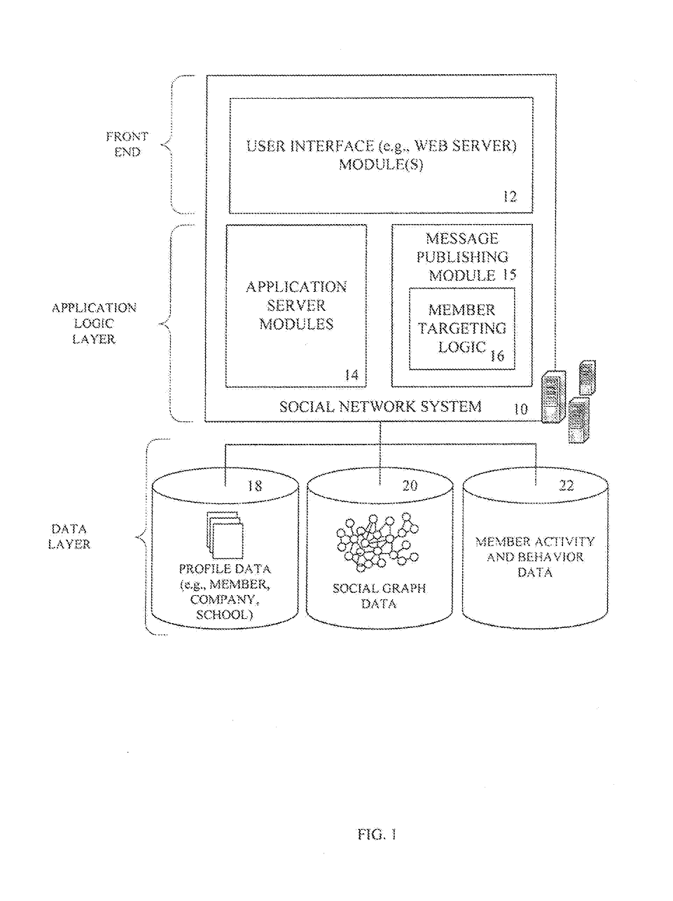

FIG. 1 is a block diagram illustrating various components or functional modules of a social network service, consistent with some embodiments. As shown in FIG. 1, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generates various user interfaces (e.g., web pages) with data retrieved from various data sources in the data layer. With some embodiments, individual application server modules 14 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 14. Similarly, a variety of other applications or services that are made available to members of the social network service will be embodied in their own application server modules 14.

As shown in FIG. 1, the data layer includes several databases, such as a database 18 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, home town, address, the names of the member's spouse and/of family members, educational background (e.g., schools, majors, matriculation and/or graduation dates, etc.), employment history, skills, professional organizations, and so on. This information is stored, for example, in the database with reference number 18. Similarly, when a representative of an organization initially registers the organization with the social network service, the representative may be prompted to provide certain information about the organization. This information may be stored, for example, in the database with reference number 18, or another database (not shown). With some embodiments, the profile data may be processed (e.g., in the background or offline) to generate various derived profile data. For example, if a member has provided information about various job titles the member has held with die same or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 20.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links selected, etc.) may be monitored and information concerning the member's behavior may be stored, for example, as indicated in FIG. 1 by the database with reference number 22. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

With some embodiments, the social network system 10 includes what is generally referred to herein as member targeting logic 16. The member targeting logic 16 enables an authorized representative of an organization, such as a company, an educational institution or school, a government entity, a non-profit organization, or any other type of organization to address a message or status update to a set of recipients who have subscribed to receive messages or status updates on behalf of the organization and who possess certain member profile attributes. Accordingly, a representative of an organization can tailor a message or status update to a particular subset of members who have subscribed to receive messages or status updates on behalf of the organization. Because the status updates can be tailored to the selected audience, the selected audience is more likely to find the content to be of interest and the overall level of engagement is increased.

Although not shown, with some embodiments, the social network system 10 provides an application programming interface (API) module via which third-party applications can access various services and data provided by the social network sen-ice. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

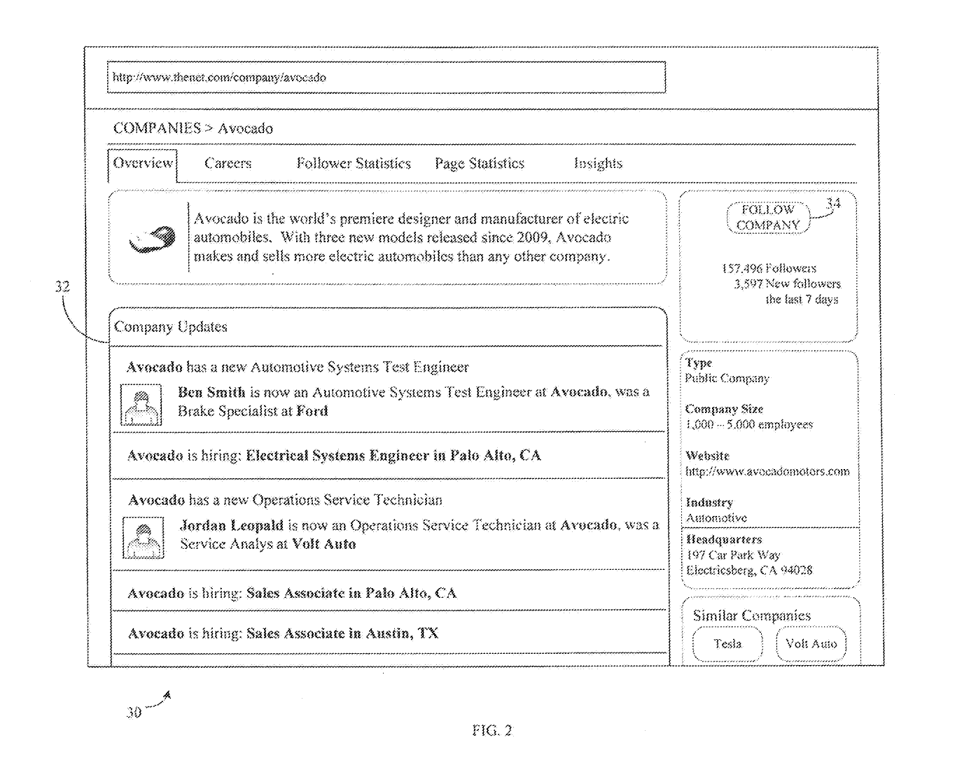

FIG. 2 is a user interface diagram illustrating an example of a user interface 30 or web page for a company represented as an entity in a social graph maintained by a social network service, consistent with some embodiments. As illustrated in FIG. 2, the example web page is for a company with the name, Avocado. In this example, a representative of the company, Avocado, has established what might be referred to as a company page 30 with the social network service. In this example, the company page for Avocado is hosted by the social network service. Accordingly, members of the social network service who may be interested in the company can access the company page for Avocado to view a variety of information about the company. For example, the company page for Avocado presents a brief history of the company as well as an overview of the products and services, that the company provides. The company page for Avocado presents information about various job listings for open employment positions with the company, for example, in connection with the “Careers” tab in FIG. 2. In connection with the “Follower Statistics” tab, the company page presents statistical information about the members of the social network service who are following the company, or who are subscribed to receive messages or status updates on behalf of the company. Such information generally includes the total number of company followers, the total number of new company followers within some predefined number of days (e.g., last seven days), the number of messages or status updates published on behalf of the company within the same predefined number of days, and so forth. In addition to follower statistics, with some embodiments the company page presents page statistics, such as, the total number of company page views, the number of company page views within some predefined number of days (e.g., last seven days), and/or the number of page or link selections (e.g., clicks) within the same predefined number of days.

With some embodiments, the company page includes various insights about the company as derived from member profile information and the viewing member's social graph. For example, in connection with the “Insights” tab in the example web page of FIG. 2, a viewing member may be presented with information identifying members of the social network service who are employed at Avocado and who have new job titles, or information about members who have recently departed Avocado for a new company. In addition, the viewing member may be presented with information about the number of members of the social network service who are in the viewing member's social graph (e.g., first degree or direct connections, followers, etc.) and who are employed at the company. The company page may present statistical information about the geographical location of residences for the employees of the company, Avocado. Of course, other insightful information may be presented as well, such as the top companies that, employees of Avocado went to subsequent to departing Avocado.

In the example of FIG. 2, various items of content are shown in separate content modules. In the portion of the example user interface with reference number 32, the company page presents a user interface for a data feed or content stream (e.g., a company updates stream), via which messages or status updates published on behalf of the company are presented. With some embodiments, the content that is presented in the company updates stream is a combination of content that has been automatically generated by some application or service of the social network service, and content that has been published by an administrator or representative of the company who has been granted the authority to publish, content on behalf of the company. With some embodiments, the messages or status updates that are published on behalf of the company are visible to all members of the social network service via the company page, regardless of whether a member is following the particular company and regardless of whether the member possesses the particular member profile attributes selected as targeting criteria by the author of the content, when the message or status update was initially published. With some alternative embodiments, status updates in the company updates stream are only visible to those members of the social network service who are following the company and/or possess the member profile attributes selected as targeting criteria by the publisher of the status update. The messages or status updates published on behalf of the company will only appear in a member's personal data feed or content stream if the member has subscribed to receive messages (e.g., if the member is following the company), and the member possesses the member profile attributes that have been selected as targeting criteria by the publisher of the status update when publishing the message.

In one content module, the company page for Avocado shows the overall number of members who are following the company via the social network service, as well as the number of new followers who have just recently (e.g., within the last seven days) begun following the company. If a member of the social network service who is viewing the company page is not currently a follower of the company, the member is presented with a graphical user interface element, such as the “Follow Company” button with reference number 34. By selecting the button 34, a member can become a follower of the company. With some embodiments, the “Follow Company” button may appear on various web pages hosted by other entities—that is, entities other than the provider of the social network service. Accordingly, members of the social network service may be presented with the opportunity to follow an organization, and thus subscribe to receive messages published on behalf of the organization, via any number of other applications, web pages or other user interfaces (e.g., mobile applications, etc.). As a follower, the member will automatically be subscribed to receive messages or status updates published on behalf of the company in a data feed or content stream that is personalized for the particular member, and for example, presented in a personalized web page or user interface of a mobile application, distinct from the company page.

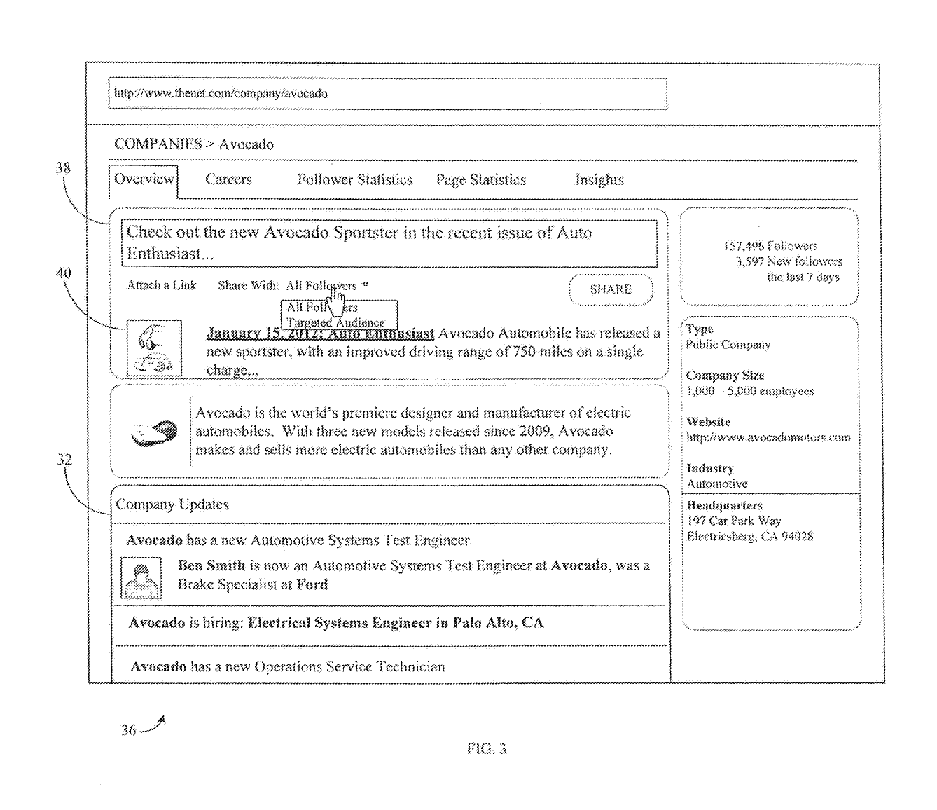

While FIG. 2 illustrates an example of a user interface or web page (e.g., a company page) as viewed from the perspective of a member of the social network service who is not following the company, FIG. 3 illustrates an alternative version or view of the same user interface or web page as presented to a member of the social network service who is both following the company and is also authorized to publish messages or status updates on behalf of the company. For instance, in the example of FIG. 3, the web page is shown as it would be presented to an employee of the Avocado company who is authorized to author and publish status updates on behalf of Avocado. Accordingly, one difference between the example user interface shown in FIG. 2 and the example shown in FIG. 3 is the inclusion of the user interface element with reference number 36 that enables publishing messages or status updates on behalf of the company, Avocado. When a member of the social network service who has been granted the appropriate privileges is logged in and properly authenticated, the member will be presented with a user interface element, such as that with reference number 38 illustrated in FIG. 3, enabling the member to author and publish messages or status updates on behalf of Avocado. In this example, the authoring tool provides a text input box via which the author can enter the text of a message or status update. In addition, a separate user interface element (e.g., the button or link with text, “Attach a Link”) enables the author to specify a link (e.g., a hyperlink) to some other web-based content, such that the link, or some portion of the actual content, is automatically included in the message or status update. In this example, the image with reference number 40 as well as the corresponding text represents content associated with a link that has been specified by the member using the “Attach a Link” button. Finally, a separate user interface element (e.g., a button or link) provides the author with the option of specifying who should receive the message or status update when published. In this example, the author can select “All Followers” to have all followers of the company receive the message or status update, or the author can select to have a “Targeted Audience” receive the published message or status update.

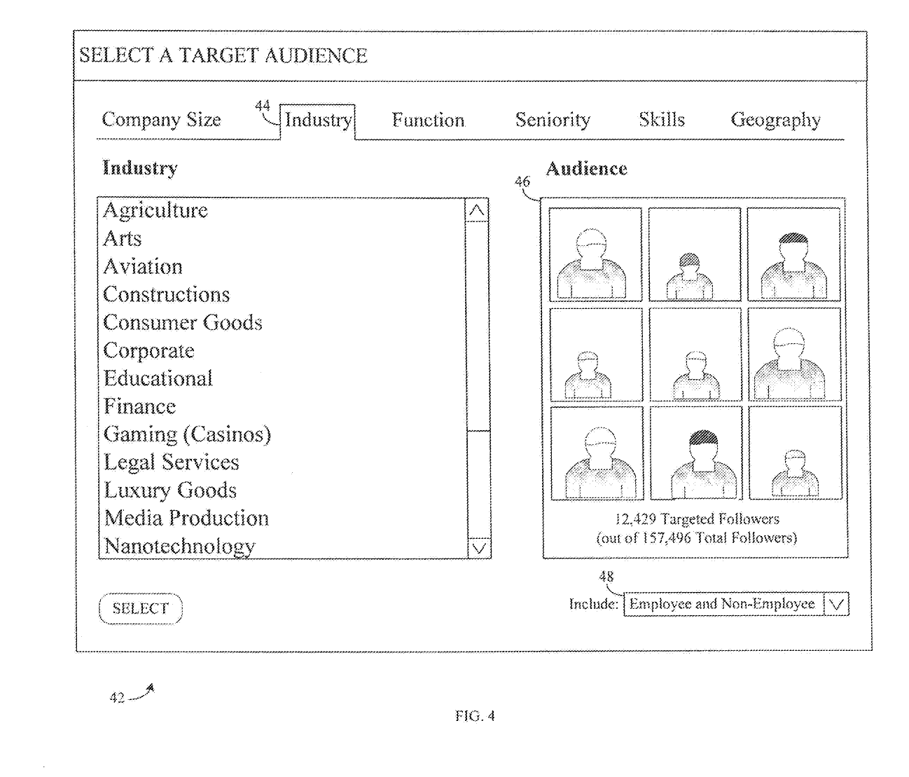

When an author selects to have a message or status update communicated to a targeted audience, the author may be presented with a user interface similar to that shown in FIG 4. In the example user interface of FIG. 4, the author of a message or status update is presented with several categories of member profile attributes, including: Company Size, Industry, Function, Seniority, Skills, and Geography. By selecting the tab associated with a particular category of member profile attribute, the author will be presented with a user interface enabling the author to select various member profile attributes as targeting criteria for selecting an intended audience of the published message or status update. In the example of FIG. 4, the currently selected tab corresponds with the “Industry” category 44. Accordingly, the author of the message or status update can select one or more industries as targeting criteria for the message or status update being published. For example, if the author publishes a message or status update after selecting the “Finance” industry as targeting criteria, only those members of the social network service who are subscribed to receive messages published on behalf of the company, and who have indicated in their member profiles that they are employed at a company in the Finance industry, will receive the published message in their personalized content stream.

As the author selects various member profile attributes, the portion of the user interface with reference number 46 is automatically updated to show profile photographs of a subset of the members of the social network service who will receive the message or status update in their respective personalized content streams, based on the currently selected targeting criteria. Additionally, as indicated in connection with reference number 48, the size of the targeted audience, based on the currently selected targeting criteria, is displayed. For instance, in the example of FIG. 4, based on the currently selected targeting criteria, 12,429 members of the social network service will receive the published message or status update in their respective personalized content streams, out of a possible 157,496 members who are eligible to receive messages published on behalf of the company because they are following the company, or have otherwise subscribed to receive information published on behalf of the company.

As indicated by reference number 48 in FIG. 4, with some embodiments, the author can select as targeting criteria whether a message or status update should be communicated to employees, non-employees, or both employees and non-employees of the company on whose behalf the message or status update is being published. For example, if an author of a message being published on behalf of Avocado would like the message to be received only by employees of the company, the author can select “Employees”, thereby limiting the audience to only employees of the company.

As illustrated in FIG. 4, other targeting criteria include company size. For example, the author of a status update may choose to publish a message to an intended audience comprised of members who are employed at companies of a certain size, for instance, as determined based on the number of employees for the company. Another targeting criteria illustrated in FIG. 4 is function (e.g., job function, or job title). For example, the author of a message or status update may choose to publish a message only to members who have indicated a particular job title (e.g., lawyer, software engineer, manager, etc.), or, members who have a particular job function as inferred from a combination of their job title and industry. With some embodiments, targeting criteria may include the various skills that each member has indicated he or she possesses. Similarly, with some embodiments, targeting criteria may include skills for which a member has been endorsed. By selecting various combinations of targeting criteria, an author of a message can ensure that the appropriate audience receives a given message or status update. In various other embodiments, any number and different combinations of other targeting criteria are possible and within the scope of the present inventive subject matter.

With some embodiments, certain of the member profile attributes presented as targeting criteria are expressly specified or provided by each member (e.g., as provided in the member's profile), whereas other member profile attributes may be inferred or derived based on one or more expressly provided member profile attributes. For instance, with some embodiments, the industry in which a member is employed may be inferred from the company at which the member is employed. Similarly, a member's seniority level may be inferred from various other expressly provided member profile information, including for example, graduation dates for schools attended, years of service at various companies, and so forth. In yet another example, a member may be classified as being in one of several different categories, based on analysis of the observed behavior of the member as relates to various content. For instance, if a member exhibits behavior (e.g., views certain content, selects certain links, joins certain groups, etc.) consistent with the behavior of someone who is looking for a new job, or, looking to purchase a particular product or service, and so on, this information may be used to classify the member into an appropriate group, which can then be used as targeting criteria.

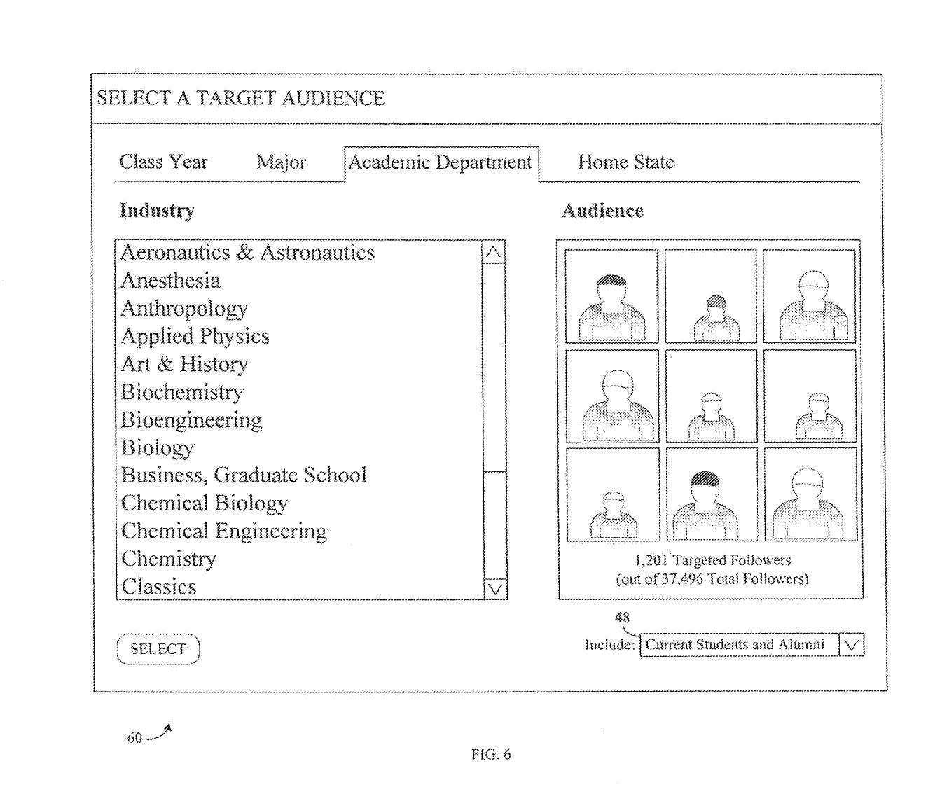

With some embodiments, the provider of the social network service determines the particular profile attributes that are presented as targeting criteria. However, with some alternative embodiments, the particular member profile attributes that are presented as targeting criteria may be customizable by members of an organization, such that one or more members who are authorized to establish the targeting criteria can select from amongst a wide variety of member profile attributes to include as selectable targeting criteria. Furthermore, the various combinations of member profile attributes presented as targeting criteria may differ depending upon the type of entity. For example, as described below in connection with FIG. 6, a school or educational institution, such as a university or college, may be presented with different selectable targeting criteria.

With some embodiments, after selecting a particular set of member profile attributes as targeting criteria for publishing a message or status update, an authorized representative of an organization may be able to save the selection for future use. For instance, if an author periodically publishes a status update to a particular intended audience (e.g., members who work in the Internet industry at companies with fewer than 200 employees, and who reside in the Austin Tex. area), the author is able to give the particular targeting criteria a name and save it to a list for later user. Consequently, the next time the author wants to publish to the same intended audience, the author can simply select the name, corresponding with the particular targeting criteria, without having to select the individual member profile attributes. Similarly, with some embodiments, the member targeting logic may automatically identify a set of members as possessing a predefined selection of member profile attributes and/or behavioral characteristics, such that these sets of members are presented as a predefined group that can be selected without manually selecting the various member profile attributes. For example, job seekers or job changers, product or service seekers, and so forth, may be automatically identified, such that they can be targeted by simply selecting a group name from a list presented by the targeting module.

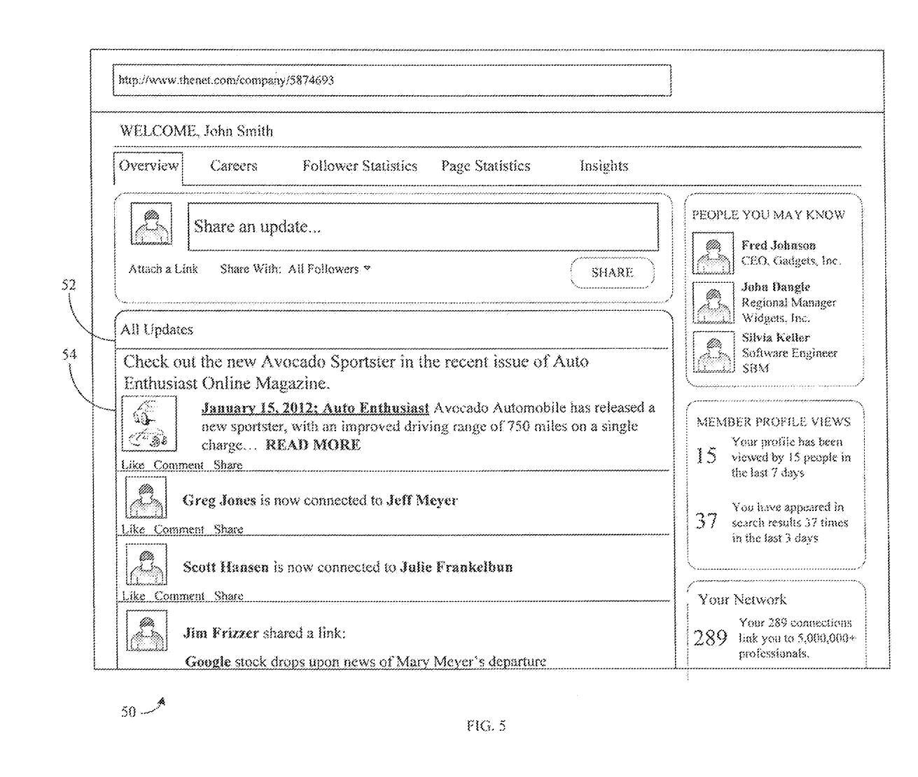

FIG. 5 is a user interface diagram illustrating an example of a user interface 50 of web page having a personalized data feed (or content stream) via which a member of a social network service receives messages or status updates, according to some embodiments. In the example user interface of FIG. 5, the content module with reference number 52 represents a personalized data feed or content stream for a member of the social network service with the name, John Smith. In this example, not only does the content stream present content selected specifically for John Smith, the content stream itself is presented within a user interface or web page that is personalized for John Smith. With some embodiments, a personalized data feed or content stream has associated with it various configuration settings that enable the user to specifically filter or select the type of content the member desires to view in the personalized content stream. In this example, the message or status update with reference number 54 is included in John Smith's personalized content stream because John Smith is following the company, Avocado, on whose behalf the message or status update has been published, and because John Smith has member profile attributes that correspond with those selected as the targeting criteria by the author of the message or status update 54.

As shown in FIG. 5, the message or status update with reference number 54 includes buttons or links that enable the viewing member to interact or engage with the message. In particular, a button labelled “like” allows the member to essentially upvote the message or express a favorable opinion of the message and its content. Similarly, a button labelled “share” allows the viewing member to share the message or status update with another member of the social network service, for example, by re-publishing the message to another member's personal data feed or content stream. Finally, a button labelled “comment” allows the user to comment on the message or status update, for example, by entering some text that will be presented with the message or status update and be visible in the personalized content streams of other members of the social network service.

With some embodiments, when a message or status update is presented to the author of the message (or other representatives of the organization on whose behalf the status update was published) in a content stream of an organization's web page, a button or link is presented, which, when selected, displays the particular targeting, criteria that was selected when the message or status update was published. Accordingly, the author of the status update can view the targeted audience (e.g., the selected member profile attributes and the size of the audience). In addition, the author of a message or status update that has been published on behalf of an organization can view various engagement statistics for the published message or status update. For example, a button or link presented in connection with a particular message or status update being viewed by the author of the message or status update may allow the author to access engagement statistics, including the number of impressions or views for the message or status update, the number of times the message or status update has been “liked”, the number of times the message or status update has been shared with others, and/or the number of times recipients of the message or status update have commented on the message or status update.

FIG. 6 is a user interface diagram illustrating an example of a user interface 60 or web page enabling a representative of a school (e.g., a college or university) to target members of a social network service to receive a message published on behalf of the school, according to some embodiments of the invention. With some embodiments, different types of entities or organizations will be presented with different member profile attributes from which to select targeting criteria. In the example of FIG. 6, the user interface is presented to enable an authorized representative of a school (e.g., college or university) to select targeting criteria to define an intended audience for a message or status update. In this example, the various categories of member profile attributes include, Class Year (e.g., senior, junior, etc.), Major, Academic Department, and Home State. In addition, as indicated in connection with reference number 62, the author of a message or status update can select to publish a message to current students of the school, alumni of the school, or both. Of course, other member profile attributes might also be presented as targeting criteria, consistent with embodiments of the invention.

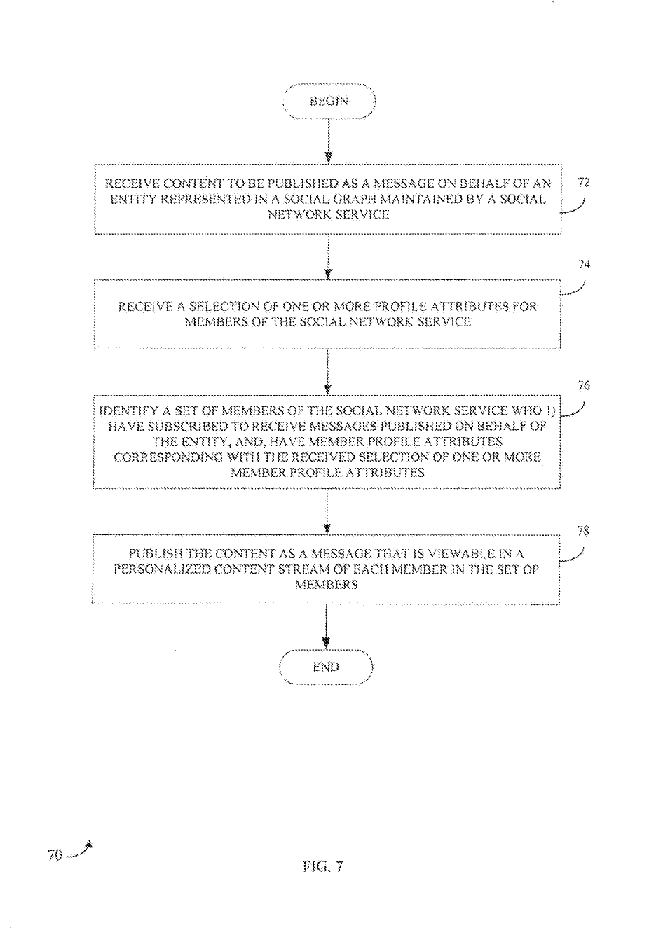

FIG. 7 is a flow diagram illustrating the method operations that occur during a method to facilitate the targeting of members of a social network service as recipients of a message or status update, according to some embodiments of the invention. At method operation 72, an application or service of the social network system receives content (e.g., text, a hyperlink or reference to some web-based content, an audio, photograph, image, or video file, etc.) that is to be published as a message or status update on behalf of an organization (e.g., a company, a school, a government entity, a non-profit, or other organization). With some embodiments, the organization will have a presence in a social graph maintained by the social network service, such that members of the social network sendee can specify some association or relationship with the organization, and/or subscribe, or opt in, to receive messages or status updates published on behalf of the organization.

At method operation 74, an application or service (e.g., member targeting logic) of the social network system receives a selection of one or more member profile attributes as targeting criteria for selecting a desired audience of members of the social network service. With some embodiments, the member profile attributes that are presented as user-selectable targeting criteria are based directly on the member profile attributes that are possessed by the members of the social network service who are following the organization. Accordingly, if there are certain member profile attributes not possessed by any member following the organization, those particular member profile attributes would not be presented as selectable targeting criteria.

Next, at method operation 76, the set of members who are both subscribed to receive messages or status updates published on behalf of the entity or organisation, and have member profile attributes that correspond with the received selection of member profile attributes (e.g., the targeting criteria), are identified. With some embodiments, a member photograph or other member profile information, such as a name, of the subset of the targeted audience may be presented in response to the author selecting various targeting criteria. Finally, at method operation 78, upon detecting interaction with a user interface element (e,g,, such as a “Submit” or “Publish” or “Post” button or link), the received content is published as a message or status update that is viewable in a personalized content stream of those members in the set of members identified at method operation 76.

Although the many examples presented herein involve publishing messages or status updates to a content stream, in other embodiments, the same member targeting logic may be used to communicate any of a wide variety of message types. For example, the member targeting logic described herein may be used to communicate an email message, a text message, or any other type of message. With some embodiments, a messaging interface may allow the message author to select the particular communication medium (e.g., status update, email, test message, etc.) By which a message is to be communicated to the desired audience.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

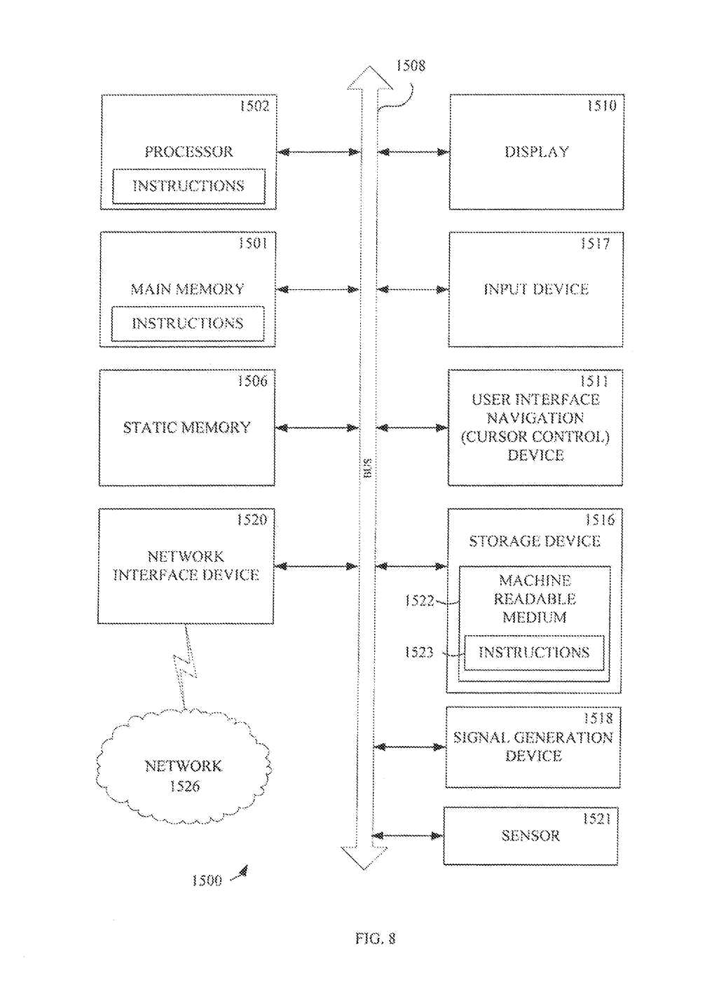

FIG. 8 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interlace device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralised or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method comprising:
at a processor-implemented message publishing module, receiving content to be published as a message in one or more content streams on behalf of an entity represented in a social graph maintained by a social network service, and a selection of one or more member profile attributes for members of the social network service, the selection of the one or more member profile attributes including a member profile attribute specifying a skill for which a member of the social network service has been endorsed, by another member, as possessing;
identifying a set of members of the social network service who have subscribed to receive, in their respective personalized content streams, messages published on behalf of the entity, and have member profile attributes corresponding with the received selection of one or more member profile attributes; and
publishing the content as a message that is viewable in a personalized content stream of each member in the set of members who have subscribed to receive messages published on behalf of the entity, and have member profile attributes corresponding with the received selection of the one or more member profile attributes.

2. The method of claim 1, wherein the set of members of the social network service who have subscribed to receive, in their respective personalized content streams, messages published on behalf of the entity are those members who have taken some affirmative action to opt in to receiving messages, in their respective personalized content streams, published on behalf of the entity.

3. The method of claim 1, wherein the entity represented in the social graph is a company and the content is received from a member of the social network service who has administrative privileges indicating authority to publish content on behalf of the company.

4. The method of claim 1, wherein the entity represented in the social graph is an educational organization and the content is received from a member of the social network service who has administrative privileges indicating authority to publish content on behalf of the educational organization.

5. The method of claim 1, further comprising:
prior to receiving the selection of the one or more member profile attributes, causing a user interface to be presented, the user interface specifying a plurality of user-selectable member profile attributes and facilitating the receiving of the selection of the one or more member profile attributes for the members of the social network service.

6. The method of claim 5, wherein the plurality of the member profile attributes includes at least one member profile attribute that is not explicitly specified or provided by a member of the social network service, but is derived or computed from one or more other member profile attributes.

7. The method of claim 1, further comprising:
subsequent to receiving a selection of each of the one or more member profile attributes, deriving the size of the set of members of the social network service who have subscribed to receive messages published on behalf of the entity, and have member profile attributes corresponding with the member profile attributes included in the received selection of the one or more member profile attributes; and
updating a user interface element to display the size of the set of members as the number of members who will receive the message in their respective personalized content stream when the message is published based on current member profile attribute selections.

8. The method of claim 1, wherein the entity represented in the social graph is a company and the member profile attribute in the selection of the one or more member profile attributes for members of the social network service specifies employment status information indicating whether a member of the social network service is, or is not, employed with the company on whose behalf the message is to be published.

9. The method of claim 1, wherein a member profile attribute in the selection of the one or more member profile attributes for members of the social network service specifies an industry in which a member of the social network service is employed.

10. The method of claim 1, wherein a member profile attribute in the selection of the one or more member profile attributes for members of the social network service specifies a job title that is associated with, or job function that is performed by, a member of the social network service.

11. The method of claim 1, wherein a member profile attribute in the selection of the one or more member profile attributes for members of the social network service specifies a company size range, measured in numbers of employees, of a company at which a member of the social network is employed.

12. The method of claim 1, wherein a member profile attribute in the selection of the one or more member profile attributes for members of the social network service specifies a seniority level of a member of the social network service.

13. The method of claim 1, wherein a member profile attribute in the selection of the one or more member profile attributes for members of the social network service specifies a geographical location in which a member of the social network service resides.

14. The method of claim 1, wherein a member profile attribute in the selection of the one or more member profile attributes for members of the social network service specifies a skill possessed by a member of the social network service.

15. (canceled)

16. The method of claim 1, wherein a member profile attribute in the selection of the one or more member profile attributes for members of the social network service specifies a job seeker status indicating whether a member of the social network service is seeking a new job.

17. The method of claim 1, wherein a member profile attribute in the selection of the one or more member profile attributes for members of the social network service specifies a field of study for which a member is seeking an academic degree, or for which a member has obtained an academic degree.

18. The method of claim 1, wherein the entity represented in the social graph is an educational organization and a member profile attribute in the selection of the one or more member profile attributes for members of the social network service specifies a class year of a member who is currently attending the educational organization.

19. The method of claim 1, wherein the entity represented in the social graph is an educational organization and a member profile attribute in the selection of the one or more member profile attributes for members of the social network service specifies a graduation year of a member who has previously attended the educational organization.

20. The method of claim 1, wherein the entity represented in the social graph is an educational organization and a member profile attribute in the selection of the one or more member profile attributes for members of the social network service specifies an academic department with which a member is associated.

21. The method of claim 1, further comprising:
publishing the content as a message in a content stream that is viewable to all members of the social network service.
